(19) United States
(12) Patent Application Publication
(10) Pub. No.: US 2022/0284153 A1
(43) Pub. Date: Sep. 8, 2022

(54) SYSTEMS AND METHOD FOR PROCESSING TOPOLOGY OPTIMIZED GEOMETRIES

(71) Applicants: SIEMENS AKTIENGESELLSCHAFT, München (DE); Siemens Industry Software Inc., Plano, TX (US)

(72) Inventors: Stefan Gavranovic, Putzbrunn (DE); Suraj Ravi Musuvathy, Princeton Junction, NJ (US); Dirk Hartmann, Aßling (DE); Peter Nanson, Cambridge (GB); Richard Collins, Cambridge (GB); Hiren Dedhia, Santa Ana, CA (US)

(21) Appl. No.: 17/632,481

(22) PCT Filed: Aug. 28, 2019
(86) PCT No.: PCT/US2019/048575

§ 371 Date: Feb. 2, 2022

(51) Int. Cl. G06F 30/20; G06F 30/10

(52) U.S. Cl. CPC G06F 30/20; G06F 30/10

(57) ABSTRACT

A computing system may include a geometry access engine configured to access geometries associated with a topology optimization process, including an original geometry that represents a design space upon which the topology optimization process applies to as well as a topology optimized geometry that represents an output of the topology optimization process performed for the original geometry. The system may also include geometry processing engine configured to generate a final geometry from the topology optimized geometry, including by conforming the topology optimized geometry to the original geometry at portions of the topology optimized geometry that correspond to fixed regions of the original geometry as well as smoothing the topology optimized geometry at portions that correspond to non-fixed regions of the original geometry.

### BACKGROUND

Computer systems can be used to create, use, and manage data for products and other items. Examples of computer systems include computer-aided design (CAD) systems (which may include computer-aided engineering (CAE) systems), computer-aided manufacturing (CAM) systems, visualization systems, product data management (PDM) systems, product lifecycle management (PLM) systems, and more. These systems may include components that facilitate the design and simulated testing of product structures and product manufacture.

### BRIEF DESCRIPTION OF THE DRAWINGS

Certain examples are described in the following detailed description and in reference to the drawings.

FIG. 1 shows an example of a computing system that supports processing of topology optimized geometries in accordance with the present disclosure.

FIG. 2 shows an example of topology optimized geometries that a computing system may access and process.

FIG. 3 shows an example of an enrichment operation by a geometry processing engine to conform a topology optimized geometry to an original geometry.

FIG. 4 shows an example a restriction operation by a geometry processing engine to conform a topology optimized geometry to an original geometry.

FIG. 5 shows an example of a conformed geometry generated through insertion of fixed regions of an original geometry into a topology optimized geometry.

FIG. 6 shows an example of smoothing that a geometry processing engine may perform for non-fixed portions of a topology optimized geometry.

FIG. 7 shows an example of logic that a system may implement to process topology optimized geometries according to the present disclosure.

FIG. 8 shows an example of logic that a system may implement to support conversion of a topology optimized geometry into a CAD geometry.

FIG. 9 shows an example of a computing system that supports processing of topology optimized geometries in accordance with the present disclosure.

### DETAILED DESCRIPTION

Additive manufacturing (sometimes referred to as 3-dimensional or 3D printing) may be performed through use of 3D printers that can construct objects on a layer-by-layer basis. With increasing capability and use of additive manufacturing technologies today, manufacture of arbitrary and complex product designs has become increasing possible. Within a given design space, previous manufacturing limitations can be overcome through additive manufacturing, and product designers now have increasing design freedoms that support optimization of manufactured objects. Moreover, additive manufacturing processes can enable the manufacturing of parts with unique physical properties through design or control of the part's geometric structure, including the design of micro-structures that form an internal geometry of the object design (e.g., lattices, internal geometric patterns, etc.).

With the increasing capability and prevalence of additive manufacturing technologies, topology optimization has become an increasingly popular design technique to generate product structures. Topology optimization may include technologies that modify material or structural layouts of an object to achieve a particular goal. Topology optimization may be used in aerospace, mechanical, bio-chemical, automotive, and many other fields to, for example, improve the performance of parts or reduce a required weight of raw materials.

While topology optimization technologies can produce part structures with increased design efficiencies, the output of topology optimization processes may require reconstruction into a geometric form suitable for 3D printing. Moreover, due to design space discretization requirements for finite element analyses (FEA) in topology optimizations, density maps or other topology optimized outputs may yield coarse, rigid, or non-smooth geometries. This may especially be the case as topology optimization discretization to high-resolution granularities may not be computationally feasible because topology optimization and FEA computations at such fine granularities may result in increased processing latencies or required computational resources that are not practical with current computing CAD, CAE, CAM, and other CAx systems.

The disclosure herein may provide systems, methods, devices, and logic for processing topology optimized geometries. In particular, the various topology optimized processing features may include smoothing of topology optimized geometries, conforming topology optimized geometries to preserve original geometry characteristics, and converting topology optimized geometries into CAD-editable models for subsequent design. Each of these various technologies are described in greater detail herein, and the disclosed processing technologies may include various technical features to increase the efficiency, feasibility, and capability of using topology optimization results to further design and manufacture 3D parts.

These and other features and technical benefits are described in greater detail herein.

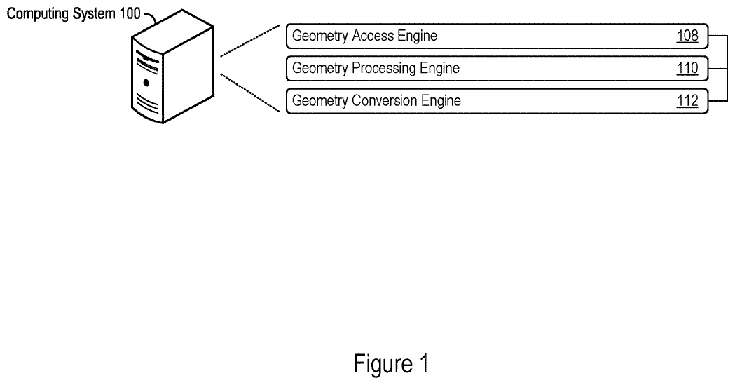

FIG. 1 shows an example of a computing system 100 that supports processing of topology optimized geometries in accordance with the present disclosure. The computing system 100 may take the form of a single or multiple computing devices such as application servers, compute nodes, desktop or laptop computers, smart phones or other mobile devices, tablet devices, embedded controllers, and more. In some examples, the computing system 100 is part of or implements (at least in part) a CAD system, a CAM system, a CAE system, any other CAx system, or a 3D printing system. In that regard, the computing system 100 may support the design, simulation, or manufacture of topology optimized part designs.

As an example implementation to support any combination of the features described herein, the computing system 100 shown in FIG. 1 includes an geometry access engine 108, a geometry processing engine 110, and a geometry conversion engine 112. The computing system 100 may implement the engines 108, 110, and 112 (including components thereof) in various ways, for example as hardware and programming. The programming for the engines 108, 110, and 112 may take the form of processor-executable instructions stored on a non-transitory machine-readable storage medium and the hardware for the engines 108, 110, and 112 may include a processor to execute those instructions. A processor may take the form of single processor or multi-processor systems, and in some examples, the computing system 100 implements multiple engines using the same computing system features or hardware components (e.g., a common processor or a common storage medium).

Note that the example implementation of the computing system 100 shown in FIG. 1 includes the geometry access engine 108, the geometry processing engine 110, and the geometry conversion engine 112. In other implementations, the computing system 100 may include only a subset of the engines 108, 110, and 112.

In operation, geometry access engine 108 may access geometries associated with a topology optimization process. In particular, the geometry access engine 108 may access an original geometry that represents a design space upon which the topology optimization process applies to as well as a topology optimized geometry that represents an output of the topology optimization process performed for the original geometry. In operation, the geometry processing engine 110 may generate a final geometry from the topology optimized geometry, including by conforming the topology optimized geometry to the original geometry at portions of the topology optimized geometry that correspond to fixed regions of the original geometry as well as smoothing the topology optimized geometry at portions that correspond to non-fixed regions of the original geometry. In operation, the geometry conversion engine 112 may convert the final geometry into a CAD-editable topology, including by extracting a triangle mesh from the final geometry, converting the triangle mesh into subdivision surfaces, and initializing a control cage for the subdivision surfaces

In that regard, the geometry access engine 108, geometry processing engine 110, and geometry conversion engine 112 may support post-processing of topology optimized geometries. These and other topology optimized geometry processing features are described in greater detail next.

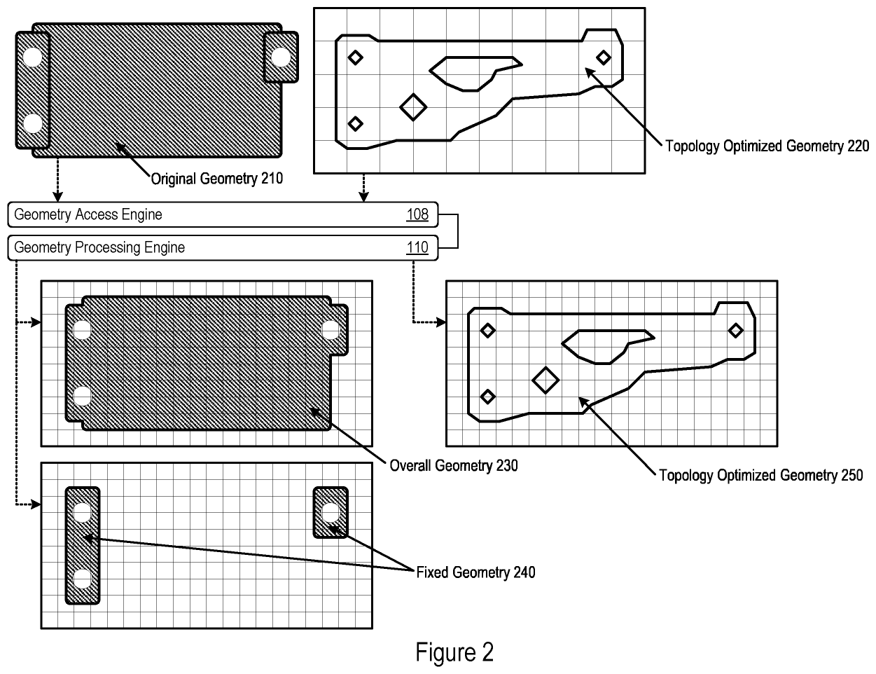

FIG. 2 shows an example of topology optimized geometries that a computing system may access and process. In the particular example shown in FIG. 2, a computing system is illustrated in the form of a geometry access engine 108 and a geometry processing engine 110. However, other system implementations are contemplated herein.

The geometry access engine 108 may access various geometries in support of post-processing topology optimization results. As seen in FIG. 2, the geometry access engine 108 may access an original geometry 210 and a topology optimized geometry 220. Each of these geometries are described in turn.

The original geometry 210 may be any geometry that represents a 3D part or object. As examples, the original geometry 210 may be a CAD model designed using CAD-based shapes and design primitives (e.g., planes, curves, lines, cylinders, cubes, 3D faces, and other solid bodies and CAD design primitives). As such, the original geometry 210 may be comprised of smooth parametrized geometries, e.g., using non-uniform rational B-Splines (NURBS) or in other forms. In some instances, the original geometry 210 may be in a form referred to as a cut model.

As another characteristic, the original geometry 210 may represent a design space upon which a topology optimization process applies to (e.g., is performed upon). Such a design space may be user-identified as an input to a topology optimization process (for which the output is the topology optimized geometry 220). In some instances, the original geometry may include fixed regions designated to remain unchanged by the topology optimization process. As such, fixed regions may represent a portion of the original geometry 210 that is fixed in design (e.g., should not change). In some cases, such fixed regions may be referred to as “keep in” or “keep out” regions for density-based topology optimizations, and may thus specify design constraints that should be adhered to in a topology optimization process.

The topology optimized geometry 220 may represent an output of the topology optimization process performed for the original geometry 210. While some of the examples are described herein in the context of density-based topology optimizations (e.g., Solid Isotrophic Material with Penalization (SIMP)-based topology optimizations), any type of topology optimization is contemplated herein. Topology optimization results may be represented in the form of a density map, as one example. As another example, density-based topology optimization results may be converted to a level-set representation, which may refer to a scalar function that encodes or otherwise represents a given geometry. As a continuing example used herein, the topology optimized geometry 220 is described as geometry encoded with a zero level set, in which a boundary of a geometry is the zero value of the level set function ϕ and the interior of the geometry is represented by negative values of the level set function ϕ. However, the topology optimized geometry processing features described herein may be consistently implemented for various other geometry representations as well.

As topology optimization may require discretization of a design space for FEA and other topology optimization computations, the topology optimized geometry 220 may likewise be represented or constructed from discretized data (e.g., a density map at a discretization granularity used for the topology optimization). To control computation latencies and required processing power, topology optimizations may be performed at a coarser discretization granularity than geometry resolutions typically used to additively manufacture objects. Consequently, reconstructing a faceted or parametric geometry for 3D printing directly from the topology optimized geometry 220 may result in a non-smooth and rough shape. This may be the case as the resolution of a topology optimization process (e.g., a discretization granularity of voxels for FEA of the original geometry 210) is coarser than the printing resolution of 3D printers, resulting in boxy or unrefined 3D printed parts.

The topology optimized geometry processing features described herein may provide post-topology optimization processing capabilities to support manufacture of topology optimized 3D parts with increased effectiveness. In some instances, such features may result in smoothed geometry representations that can be extracted into parametric representations and 3D printed to produce 3D parts with improved aesthetics or mechanical stability. In processing topology optimized geometries, the features described herein may increase the accuracy of 3D part designs by conforming fixed design regions to original geometry designs, smoothing topology optimization results at finer resolutions to improve part structures, converting topology optimization results into CAD-editable forms to support subsequent design adjustments, or any combination thereof.

In order to post-process topology optimization results, the geometry processing engine 110 may represent various geometries at a finer granularity (also referred to herein as a finer resolution) than the discretization resolution used to perform a topology optimization for a part design. As used herein, the “finer granularity” may refer to mesh or geometry resolution used to post-process topology optimized results that is finer or higher in resolution/granularity than that used by a topology optimization process to generate the topology optimization results. In the example shown in FIG. 2, the geometry processing engine 110 represents the original geometry 210 and the topology optimized geometry 220 at a finer granularity than a discretization granularity used to generate the topology optimized geometry 220.

In some cases, the geometry processing engine 110 refines the resolution by a factor of 2, but the degree to which the geometry processing engine 110 enhances resolution may be configurable (e.g., 4×, 8×, 16×, etc.) and dependent upon computational latency requirement, available computing resources, etc. Resolution enhancement by the geometry processing engine 110 may be performed, for example, by equally subdividing voxels (or other discrete elements) of the topology optimized geometry 220 into the finer resolution. In FIG. 2, the geometry processing engine 110 represents three geometries in a finer granularity, shown as the overall geometry 230, the fixed geometry 240, and the topology optimized geometry 250.

The overall geometry 230 and the fixed geometry 240 may be represented from the original geometry 210, e.g., by discretizing the original geometry 210 (or portions thereof) at the finer granularity and representing the discretized original geometry as level set representations (or any other geometric form). The overall geometry 230 may set boundary limits of the design space of the original geometry 210 upon which a topology optimization process applies to (e.g., an initial input geometry, with bounding boxes or other design spaces to optimize as well as fixed regions in the initial input geometry). The fixed geometry 240 may include a portion of the design space of the original geometry 210 that is designated not to change from the topology optimization process (e.g., the fixed regions of the original geometry 210). As subsequently described, the geometry processing engine 110 may use the overall geometry 230 and the fixed geometry 240 to conform topology optimized geometries to correspond to fixed regions of the original geometry 210.

The geometry processing engine 110 may represent the topology optimized geometry 250 by discretizing the topology optimized geometry 220 at the finer granularity (e.g., enhancing the mesh resolution by a factor of 2, 4, 8, 16, etc.). In that regard, the geometry (e.g., represented shape) of the topology optimized geometry 250 may be identical to that of the topology optimized geometry 220, but discretized at a finer granularity to support conforming and smoothing operations as described herein.

In some implementations (and as a continuing example herein), the geometry processing engine 110 may represent the overall geometry 230, fixed geometry 240, and the topology optimized geometry 250 as level-set representations, which may be referred to herein respectively as ϕ_{OG} (for the overall geometry 230), ϕ_{FG} (for the fixed geometry 240), and ϕ_{TO} (for the topology optimized geometry 250). Moreover, some the examples described herein depict level set representations on a full rectangular grid, but the geometry processing engine 110 may support level set representations according to narrow band methods to provide increased processing efficiency.

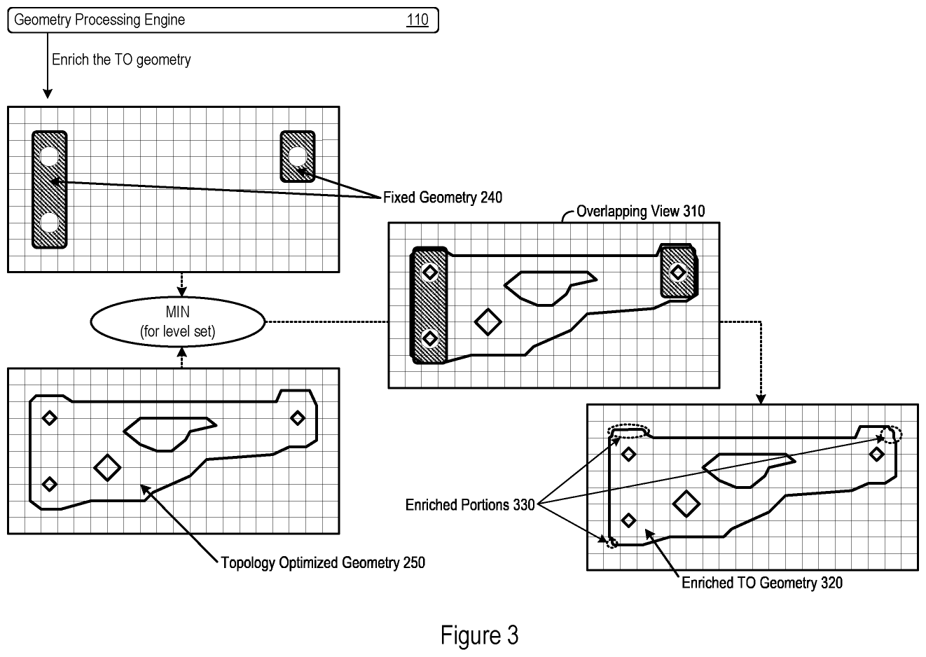

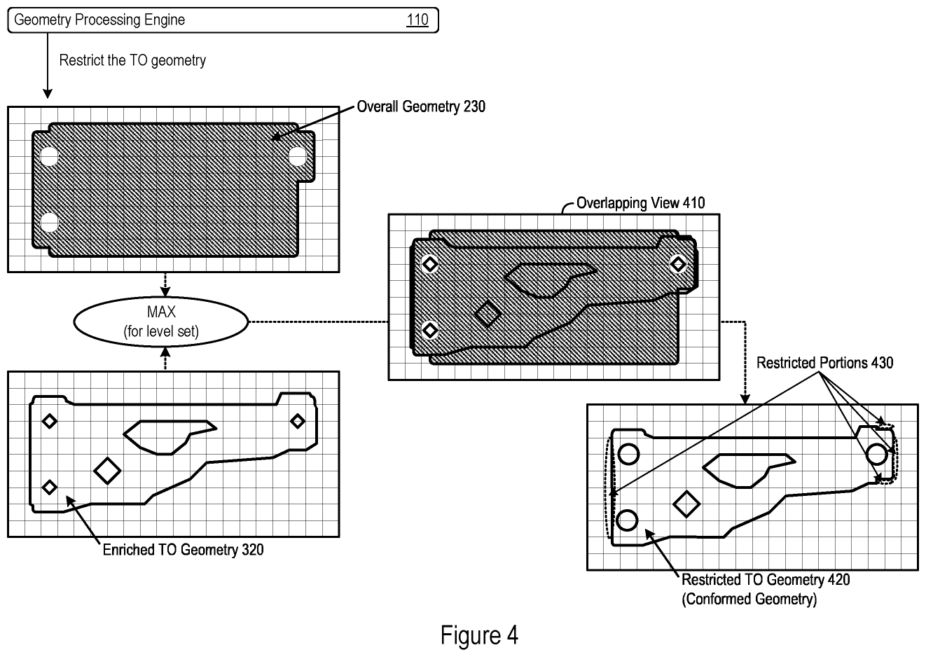

To conform portions of the topology optimized geometry 250 to the original geometry 210, the geometry processing engine 110 may enrich the topology optimized geometry 250 with the fixed geometry 240, restrict the topology optimized geometry 250 with the overall geometry 240, or a combination of both. Examples of such features are described next in connection with FIGS. 3 and 4.

FIG. 3 shows an example of an enrichment operation by the geometry processing engine 110 to conform the topology optimized geometry to an original geometry. In particular, the geometry processing engine 110 may enrich the topology optimized geometry 250 (represented at the finer granularity) with the fixed geometry 240 (extracted from the original geometry 210 and also represented at the finer granularity).

In performing the enrichment operation, the geometry processing engine 110 may add, into the topology optimized geometry 250, any fixed portions of the original geometry 210 (as represented by the fixed geometry 240) that were removed by a topology optimization process used to generate the topology optimized geometry 220 (and now represented as the topology optimized geometry 250). Such enriching may be performed by overlaying the fixed geometry 240 on the topology optimized geometry 250 (or vice versa) and ensuring any “keep-in”, solid, or interior portions of the fixed geometry 240 are likewise represented as solid and interior portions of the topology optimized geometry 250.

In FIG. 3, an example overlay is illustrated through the overlapping view 310, in which can be seen certain portions of the fixed geometry 240 are not included as solid or interior to the geometry of the topology optimized geometry 250. As such, the geometry processing engine 110 may modify the topology optimized geometry 250 to include these missing portions of the fixed geometry 240, thereby enriching the topology optimized geometry 250. Put another way, the geometry processing engine 110 may enrich the topology optimized geometry 250 to include portions of the fixed geometry 240 that are missing in the topology optimized geometry 250 due to removal by a topology optimization process, doing so at a finer granularity than the discretization granularity used for the topology optimization process. An example output of an enrichment operation by the geometry processing engine 110 is shown in FIG. 3 as the enriched TO geometry 320, and portions at which solid geometries are reintroduced by the geometry processing engine 110 are shown as the enriched portions 330.

In examples in which the fixed geometry 240 and topology optimized geometry 250 are represented as zero level sets with interior geometries represented by negative values of a level set function ϕ, the geometry processing engine 110 may perform the enrichment operation as a minimum function. As such, the geometry processing engine 110 may generate the enriched TO geometry 320 (with a level set function of ϕ_{eTO}) as ϕ_{eTO}=min(ϕ_{TO}, ϕ_{FG}).

Accordingly, the geometry processing engine 110 may enrich a topology optimized geometry to include fixed portions of an original geometry that were removed from a design by topology optimization.

FIG. 4 shows an example of a restriction operation by the geometry processing engine 110 to conform a topology optimized geometry to an original geometry. In particular, the geometry processing engine 110 may restrict the enriched TO geometry 320 (represented at the finer granularity) with the overall geometry 230 (as extracted from the original geometry 210 and also represented at the finer granularity).

In performing the restriction operation, the geometry processing engine 110 may remove, from a topology optimized geometry (such as the enriched TO geometry 320) any additional portions, added by the topology optimization process used to generate the topology optimized geometry 220, that extend beyond a boundary of the design space of the original geometry 210. Such restricting may be performed by overlaying the overall geometry 230 on the enriched TO geometry 320 (or vice versa) and ensuring that (i) any “keep-out” portions of the fixed geometry 240 are likewise represented as empty or exterior shape portions of a topology optimized geometry (e.g., the enriched TO geometry 250) as well as (ii) solid portions of the topology optimized geometry (e.g., the enriched TO geometry 320) do not extend beyond the external boundaries of the overall geometry 230.

In FIG. 4, an example overlay is illustrated through the overlapping view 410, in which can be seen certain portions of the enriched TO geometry 320 extend beyond a boundary of the overall geometry 230. As such, the geometry processing engine 110 may modify the enriched TO geometry 320 to remove these additional portions of the enriched TO geometry 320 that extend beyond an allowable design space, thereby restricting the enriched TO geometry 320. Additionally or alternatively, the geometry processing engine 110 may perform the restriction operation to remove portions of the enriched TO geometry 320 that correspond to fixed regions of the original geometry 210 configured to be non-solid or empty, thereby ensuring that fixed “keep-out” regions of the original geometry 210 are adhered to in a topology optimized design.

As described herein, the geometry processing engine 110 may restrict a topology optimized geometry (e.g., the enriched TO geometry 320) to exclude portions of the topology optimized geometry that extend beyond the overall geometry 230, exclude portions of the topology optimized geometry that are designated as fixed empty regions in the original geometry 210, or a combination of both. The geometry processing engine 110 may do so at the finer granularity. An example output of a restriction operation by the geometry processing engine 110 is shown in FIG. 4 as the restricted TO geometry 420, and some examples of restricted portions 430 at which solid geometries extending beyond a design space boundary are removed are shown as the restricted portions 430.

In examples in which the fixed geometry 240 and enriched TO geometry 320 are represented as zero level sets with interior geometries represented by negative values of a level set function ϕ, the geometry processing engine 110 may perform the restriction operation as a maximum function. As such, the geometry processing engine 110 may generate the restricted TO geometry 420 (with a level set function of ϕ_{rTO}) as ϕ_{rTO}=max(ϕ_{eTO}, ϕ_{OG}).

Note that in the example shown in FIG. 4, the geometry processing engine 110 performs a restriction operation on the enriched TO geometry 320, as doing so may preserve the results of an enrichment operation previously performed by the geometry processing engine 110. Consequently, the restricted TO geometry 420 shown in FIG. 4 also includes enriched portions 330 added into a topology optimized geometry to conform to fixed regions of an original geometry.

While the ordering of FIGS. 3 and 4 provide an illustrative example of performing an enrichment operation prior to performing a restriction operation, alternative orderings are possible by the geometry processing engine 110. For example, the geometry processing engine 110 may perform a restriction operation between the overall geometry 230 and the topology optimized geometry 250 to generate a given restricted TO geometry, and then subsequently perform the enrichment operation between the given restricted TO geometry and the fixed geometry 240.

In that regard, the geometry processing engine 110 may enrich and restrict a topology optimized geometry (in various orders) to conform the topology optimized geometry to fixed regions an original geometry. The restricted TO geometry 420 shown in FIG. 4 may represented a conformed geometry in that the restricted TO geometry 420 represents the fixed geometry 420 of the original geometry 210 and does not extend beyond the overall geometry 230 of the original geometry 210. Understood in a different way, a conformed geometry may be generated by the geometry processing engine 110 to represent fixed regions of an original design at finer granularity than a discretization granularity of a topology optimization process.

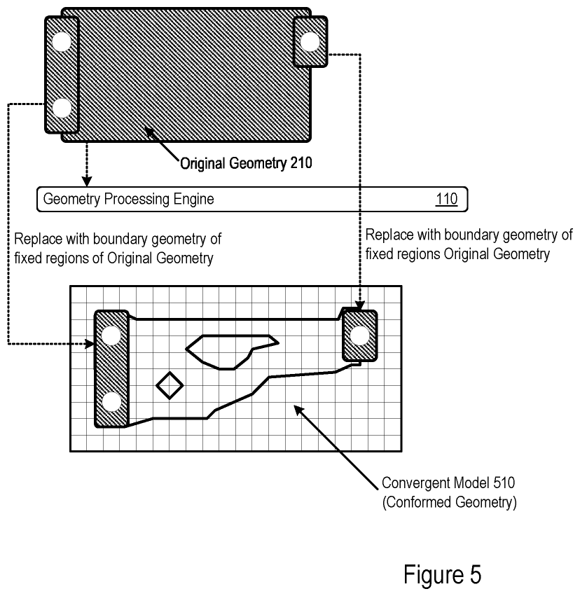

In FIGS. 3 and 4, the geometry processing engine 110 may conform a topology optimized geometry to an original geometry via geometric operations performed for a given representation of the geometries (e.g., zero level sets at a finer granularity). In some implementations, the geometry processing engine 110 may conform topology optimized geometries to original geometries by directly inserting portions (e.g., fixed regions) of an original geometry into the topology optimized geometry, as discussed in greater detail next in connection with FIG. 5.

FIG. 5 shows an example of a conformed geometry generated through insertion of fixed regions of an original geometry into a topology optimized geometry. The geometry processing engine 110 may generate a conformed geometry via the features described in FIG. 5, for example as an alternative to the geometry conforming features as described for FIGS. 3 and 4.

In particular, the geometry processing engine 110 may identify portions of a topology optimized geometry that correspond to correlated portions of an original geometry 210 and replace such portions of the topology optimized geometry directly with the geometry of the original geometry. Using the original geometry 210 described in FIG. 2 as an illustrative example, the geometry processing engine 110 may identify such correlated portions as fixed regions of the original geometry 210. As such, the geometry processing engine 110 may replace the portions of a topology optimized geometry (e.g., the topology optimized geometry 220 or 250) that correspond to fixed regions of the original geometry 210 with the original geometry at the fixed regions.

That is, the geometry processing engine 110 may reconstruct portions of the original geometry 210 directly into a topology optimized geometry. Additionally or alternatively, the geometry processing engine 110 may input, align, or otherwise insert the boundary geometry of fixed regions of the original geometry 210 into topology optimized geometry, which may directly preserve the original design intent of a part design. In doing so, the geometry processing engine 110 may restrict or enrich portions of the topology optimized geometry directly with the boundary geometry itself of the original geometry 210 (e.g., corresponding portions thereof to form the exterior boundary of the topology optimized geometry). Explained in yet another way, the geometry processing engine 110 may adapt, insert, or configure geometry boundaries of the topology optimized geometry directly with geometry boundaries (or portions thereof) of fixed regions of the original geometry 210 (but need not enforce or insert internal boundaries of fixed regions that do not affect or form a geometry boundary of the topology optimized geometry). By doing so, the geometry processing engine 110 may support tighter integration of topology optimized geometries with the original geometry 210 from which a topology optimized geometry is generated from.

The reconstructed portions may be inserted into a topology optimized geometry as boundary geometries, cut models, CAD design primitives, or in any other CAD-editable form. In that regard, a conformed geometry generated in such a way by the geometry processing engine 110 may include multiple types of geometric representations in the same design. As an example shown in FIG. 5, the geometry processing engine 110 may generate a convergent model 510 in which fixed regions of the original geometry 220 are represented as computer-aided design (CAD) geometry and non-fixed regions of a topology optimized geometry are represented as facets (e.g., at a finer granularity). As such, the convergent model 510 may be in the form of a single object model, with a combination of facet and classic geometry.

As noted herein, to generate the convergent model 510, the geometry processing engine 110 may identify portions of a topology optimized geometry 250 that correspond to the fixed regions, and replace those identified directly with the fixed regions of the original geometry 210 (e.g., directly with CAD design primitives). Through insertion of portions of an original geometry into a topology optimized geometry, such features may preserve design intent and associativity and provide for downstream processing of such regions (e.g., for CAM simulations) with increased efficiency.

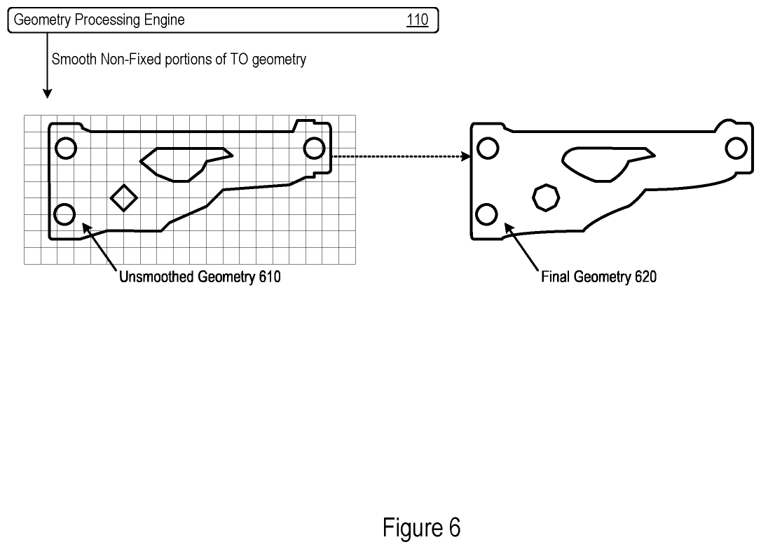

In FIG. 5, the convergent model 510 generated by the geometry processing engine 110 may be a conformed geometry in that a topology optimized geometry has been processed to conform (in this case directly) to fixed regions of the original geometry 210. The geometry processing engine 110 may conform a topology optimized geometry through insertion of original geometry portions before or after smoothing other portions of the topology optimized geometry. In some implementations, the geometry processing engine 110 conforms a topology optimized geometry (e.g., according to any of the features described in connection with FIGS. 3-5) prior to smoothing non-fixed portions of the topology optimized geometry. Doing so may increase efficiency by reducing the portion of a topology optimized geometry required to be processed to smooth the geometry. Smoothing is described next in connection with FIG. 6.

FIG. 6 shows an example of smoothing that the geometry processing engine 110 may perform for non-fixed portions of a topology optimized geometry. In FIG. 6, the geometry processing engine 110 performs a smoothing operation for an unsmoothed geometry 610, which may be a conformed geometry such as the restricted TO geometry 420 described in FIG. 4 or the convergent model 510 described in FIG. 5.

The geometry processing engine 110 may smooth the unsmoothed geometry 610 through geometric flows. For instance, the geometry processing engine 110 may solve the following evolution equation, described using a conformed topology optimized geometry level set function ϕ_{cTO} as an example:

$$\frac{\partial }{\partial t} {ϕ}_{cTO} + V \vert {ϕ}_{cTO} \vert = 0$$

In this example, the geometry processing engine 110 may set V equal to zero (0) at fixed regions of the unsmoothed geometry 610 to ensure the fixed (e.g., conformed) regions of the unsmoothed geometry 610 do not change from the smoothing, thereby preserving the fixed regions of the original geometry 220 conformed into the unsmoothed geometry 610. In the remaining portions of the domain, e.g., the non-fixed portions of the unsmoothed geometry 610, the geometry processing engine 110 may smooth the curves via geometry flows, such as mean curvature flow or Willmore Flow as two examples.

By applying such smoothing processes, the geometry processing engine 110 may generate the final geometry 620. Since non-fixed portions of the unsmoothed geometry 610 may be represented at finer granularity than a discretization granularity applied for topology optimization, the smoothing operations may result in increased smoothness of curves in the final geometry 620 as compared to the topology optimized geometry 220.

From the final geometry, the geometry processing engine 110 may extract a tessellated or triangular-faceted geometry, e.g., via Marching Cubes or dual contouring, which may then be provided to a 3D printing system for additive manufacture. In some implementations, the geometry processing may further conform a tessellated or triangular-faceted geometry extracted from the final geometry 620. As one example, the geometry processing engine 110 may perform a Boolean operation between a mesh representation of the final geometry 620 and the original geometry 220 to remove distortions to the final geometry 520 that extend beyond boundaries of the original geometry 220. As another example, the geometry processing engine 110 may perform triangle smoothing on an extracted representation to smooth a design prior to additive manufacture.

In some implementations, further processing may be performed on the final geometry 620 or a faceted geometry extracted from the final geometry 620. Such processing may include conversion into a parametric geometry to support CAD editing which may be performed by a geometry conversion engine 112 as described in greater detail subsequently herein.

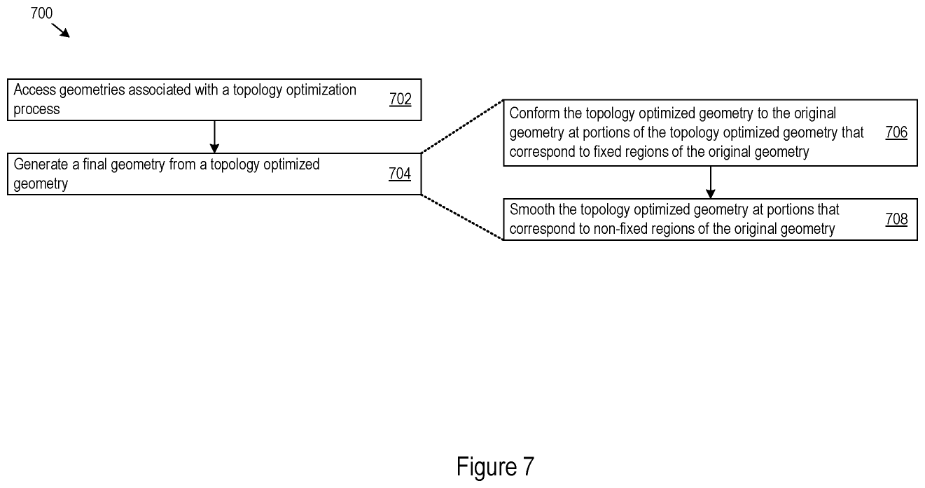

FIG. 7 shows an example of logic that a system may implement to process topology optimized geometries according to the present disclosure. For example, the computing system 100 may implement the logic 700 as hardware, executable instructions stored on a machine-readable medium, or as a combination of both. The computing system 100 may implement the logic 700 via the geometry access engine 108 and the geometry processing engine 110, through which the computing system 100 may perform or execute the logic 700 as a method to post-process topology optimized geometries. The following description of the logic 700 is provided using the geometry access engine 108 and the geometry processing engine 110 as examples. However, various other implementation options by systems are possible.

In implementing the logic 700, the geometry access engine 108 may access geometries associated with a topology optimization process (702). Accessed geometries may include an original geometry that represents a design space upon which the topology optimization process applies to and a topology optimized geometry that represents an output of the topology optimization process performed for the original geometry. In implementing the logic 700, the geometry processing engine 110 may generate a final geometry from the topology optimized geometry (704), and generation of the final geometry may include performing conforming and smoothing operations on various portions of the topology optimized geometry.

For instance, the geometry processing engine 110 may conform the topology optimized geometry to the original geometry at portions of the topology optimized geometry that correspond to fixed regions of the original geometry (706). In doing so, the geometry processing engine 110 may generate a conformed geometry, whether by enrichment and restriction operations as described herein or by direct insertion of fixed regions of the original geometry into the topology optimized geometry, as also described herein. The geometry processing engine 110 may smooth topology optimized geometry at portions that correspond to non-fixed regions of the original geometry (708), e.g., by smoothing a conformed geometry via geometric flows.

The logic 700 shown in FIG. 7 provides an illustrative example by which a computing system 100 may support processing of topology optimized geometries. Additional or alternative steps in the logic 700 are contemplated herein, including according to any features described herein for the geometry access engine 108, geometry processing engine 110, geometry conversion engine 112, or any combinations thereof.

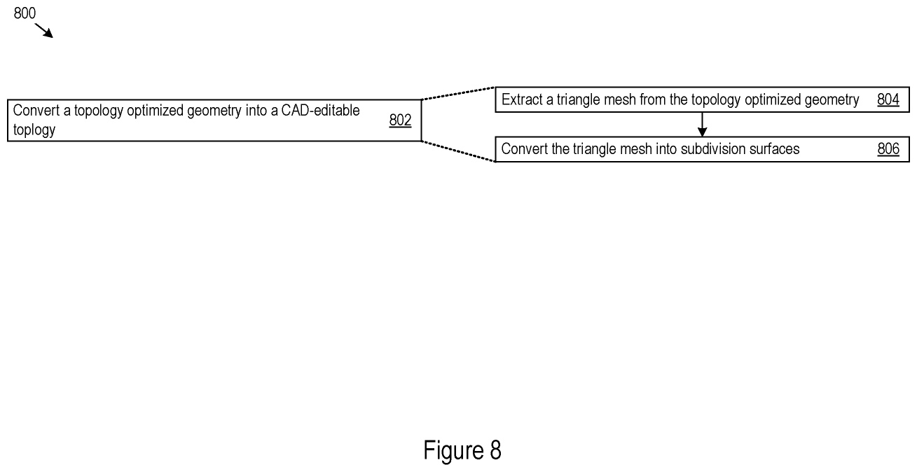

FIG. 8 shows an example of logic 800 that a system may implement to support conversion of a topology optimized geometry into a CAD geometry. For example, the computing system 100 may implement the logic 800 as hardware, executable instructions stored on a machine-readable medium, or as a combination of both. The computing system 100 may implement the logic 700 via the geometry conversion engine 112, through which the computing system 100 may perform or execute the logic 700 as a method to post-process topology optimized geometries to convert the geometries into parametric or CAD-editable forms. The following description of the logic 800 is provided using the geometry conversion engine 112 as an example. However, various other implementation options by systems are possible.

In implementing the logic 800 and in operation, the geometry conversion engine 112 may convert a topology optimized geometry into a CAD-editable geometry (802). For instance, the geometry conversion engine 112 may convert the final geometry 620 described in FIG. 6, which maybe conformed to an original geometry and smoothed to support subsequent additive manufacture. The final geometry 620 (another other topology optimized geometries described herein) may be discrete models, and the geometry conversion engine 112 may support transformation of such discrete models into CAD models, which may support further design and edits via a CAD system or application.

To convert a topology optimized geometry, the geometry conversion engine 112 may extract a triangle mesh from the topology optimized geometry (804). Isosurface extraction or other triangular meshing techniques may be used, e.g., to convert density maps generated by topology optimization processes into a triangular mesh. For geometries represented as level set functions (e.g., as described herein), the geometry conversion engine 112 may apply any number or tessellation or triangularization processes. In some instances, the geometry conversion engine 112 may further smooth the surface and remove jagged edges or other noisy artifacts as well, e.g., via standard surface mesh processing techniques.

The geometry conversion engine 112 may convert the triangle mesh into subdivision surfaces (806), doing so in various ways. In some examples, the geometry conversion engine 112 may decimate or otherwise simplify the triangle mesh using edge collapse operations. Then, the geometry conversion engine 112 may convert the decimated triangle mesh into a quadrilateral mesh, the quadrilaterals in the quadrilateral mesh may form a control cage through which subdivision surfaces can be generated via a subdivision process. As such, the geometry processing engine 110 may initialize a control cage with the quadrilateral mesh. As another example, the geometry conversion engine 112 may convert the triangle mesh into a quadrilateral mesh and then coarsen the quadrilateral mesh, in which the coarsened quadrilateral mesh may form the subdivision surfaces through the subdivision process. In this example, the geometry processing engine 110 may initialize a control cage from the coarsened quadrilateral mesh. Subdivision surfaces may be form from initialized control cages. Through subdivision processes of the control cage, a limit surface in a geometric shape that matches the topology optimized geometry may be formed to support editing via CAD processes.

In some instances, the geometry conversion engine 112 may initialize a control cage for the subdivision surfaces, doing so from the quadrilateral mesh formed from the triangle mesh. A control cage may be any CAD functionality that surrounds CAD faces that support manipulate underlying limit surfaces (e.g., faces formed by subdivision surfaces and the subdivision process). Control cages may be supported by various CAD systems, and the subdivision surfaces (e.g., limit surfaces) converted from the topology optimized geometry may provide references or anchors for the control cage, allowing subsequent CAD-based editing and modifications to a topology optimized geometry.

In some instances, the geometry conversion engine 112 may further adapt parameters of the control cage, e.g., by performing surface fitting to fit a triangular surface of the subdivision surfaces, adjusting weights of cage edges to create creases in the control cage, or combinations of both.

The logic 800 shown in FIG. 8 provides an illustrative example by which a computing system 100 may support converting of topology optimized geometries into CAD-editable forms. Additional or alternative steps in the logic 800 are contemplated herein, including according to any features described herein for the geometry access engine 108, geometry processing engine 110, geometry conversion engine 112, or any combinations thereof.

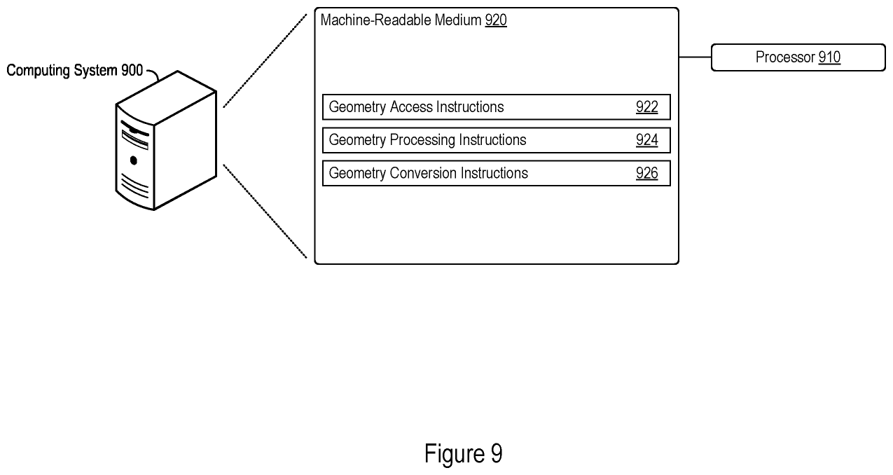

FIG. 9 shows an example of a computing system 900 that supports processing of topology optimized geometries in accordance with the present disclosure. The computing system 900 may include a processor 910, which may take the form of a single or multiple processors. The processor(s) 910 may include a central processing unit (CPU), microprocessor, or any hardware device suitable for executing instructions stored on a machine-readable medium. The system 900 may include a machine-readable medium 920. The machine-readable medium 920 may take the form of any non-transitory electronic, magnetic, optical, or other physical storage device that stores executable instructions, such as the geometry access instructions 922, the geometry processing instructions 924, and the geometry conversion instructions 926 shown in FIG. 9. As such, the machine-readable medium 920 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 900 may execute instructions stored on the machine-readable medium 920 through the processor 910. Executing the instructions (e.g., the geometry access instructions 922, the geometry processing instructions 924, and/or the geometry conversion instructions 926) may cause the computing system 900 to perform any of the features described herein, including according to any of the features with respect to the geometry access engine 108, the geometry processing engine 110, the geometry conversion engine 112, or any combinations thereof.

For example, execution of the geometry access instructions 922 by the processor 910 may cause the computing system 900 to access geometries associated with a topology optimization process. The accessed geometries may include an original geometry that represents a design space upon which the topology optimization process applies to and a topology optimized geometry that represents an output of the topology optimization process performed for the original geometry.

Execution of the geometry processing instructions 924 by the processor 910 may cause the computing system 900 to generate a final geometry from the topology optimized geometry, including by conforming the topology optimized geometry to the original geometry at portions of the topology optimized geometry that correspond to fixed regions of the original geometry as well as smoothing the topology optimized geometry at portions that correspond to non-fixed regions of the original geometry.

Execution of the geometry conversion instructions 926 by the processor 910 may cause the computing system 900 to convert the final geometry into a CAD-editable topology, including by extracting a triangle mesh from the final geometry, converting the triangle mesh into subdivision surfaces, and initializing a control cage for the subdivision surfaces.

Any additional or alternative features as described herein may be implemented via the geometry access instructions 922, geometry processing instructions 924, geometry conversion instructions 926, or any combinations thereof.

The systems, methods, devices, and logic described above, including the geometry access engine 108, the geometry processing engine 110, and the geometry conversion engine 112, may be implemented in many different ways in many different combinations of hardware, logic, circuitry, and executable instructions stored on a machine-readable medium. For example, the geometry access engine 108, the geometry processing engine 110, the geometry conversion engine 112, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the geometry access engine 108, the geometry processing engine 110, the geometry conversion engine 112, or combinations thereof.

The processing capability of the systems, devices, and engines described herein, including the geometry access engine 108, the geometry processing engine 110, and the geometry conversion engine 112, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
accessing geometries associated with a topology optimization process, the geometries comprising:
an original geometry that represents a design space upon which the topology optimization process applies to; and
a topology optimized geometry that represents an output of the topology optimization process performed for the original geometry; and
generating a final geometry from the topology optimized geometry by:
conforming the topology optimized geometry to the original geometry at portions of the topology optimized geometry that correspond to fixed regions of the original geometry; and
smoothing the topology optimized geometry at portions that correspond to non-fixed regions of the original geometry.

2. The method of claim 1, wherein conforming the topology optimized geometry to the original geometry comprises:
replacing the portions of the topology optimized geometry that correspond to fixed regions of the original geometry with the original geometry at the fixed regions.

3. The method of claim 2, comprising generating the final geometry as a convergent model,
wherein the fixed regions of the original geometry in the final geometry are represented as computer-aided design (CAD) geometry and the smoothed portions of the topology optimized geometry are represented as facets.

4. The method of claim 1, wherein smoothing the topology optimized geometry comprises:
representing the topology optimized geometry at a finer granularity than a discretization granularity used for the topology optimization; and
smoothing the topology optimized geometry at the finer granularity.

5. The method of claim 1, wherein the original geometry comprises:
an overall geometry that sets boundary limits of the design space upon which the topology optimization process applies to; and
a fixed geometry that comprises a portion of the design space that is designated not to change; and
wherein conforming the topology optimized geometry to the original geometry at portions of the topology optimized geometry that correspond to fixed regions of the original geometry comprises:
representing the overall geometry, the fixed geometry, and the topology optimized geometry at a finer granularity than a discretization granularity used for the topology optimization;
enriching, at the finer granularity, the topology optimized geometry to include portions of the fixed geometry that are missing in the topology optimized geometry due to removal by the topology optimization process; and
restricting, at the finer granularity, the topology optimized geometry to exclude portions of the topology optimized geometry that extend beyond the overall geometry.

6. The method of claim 1, wherein the final geometry comprises a level-set geometry representation, and further comprising:
extracting a mesh representation of the final geometry from the level-set geometry representation;
performing a Boolean operation between the mesh representation of the final geometry and the original geometry to remove a distortion to the final geometry that extends beyond the original geometry.

7. The method of claim 6, further comprising, in addition to smoothing the topology optimized geometry, smoothing the mesh representation of the final geometry.

8. The method of claim 1, further comprising converting the final geometry into a computer-aided design (CAD)-editable topology by:
extracting a triangle mesh from the final geometry; and
converting the triangle mesh into subdivision surfaces.

9. The method of claim 8, wherein converting the triangle mesh into the subdivision surfaces comprises:
decimating the triangle mesh using edge collapse operations;
converting the decimated triangle mesh into a quadrilateral mesh; and
initializing a control cage from the quadrilateral mesh.

10. The method of claim 8, wherein converting the triangle mesh into the subdivision surfaces comprises:
converting the triangle mesh into a quadrilateral mesh;
coarsening the quadrilateral mesh; and
initializing a control cage from the coarsened quadrilateral mesh.

11. The method of claim 8, further comprising adapting parameters of the control cage by performing surface fitting to fit a triangular surface of the subdivision surfaces, adjusting weights of cage edges to create creases in the control cage, or a combination of both.

12. A system comprising:
a geometry access engine configured to access geometries associated with a topology optimization process, the geometries comprising:
an original geometry that represents a design space upon which the topology optimization process applies to; and
a topology optimized geometry that represents an output of the topology optimization process performed for the original geometry; and
a geometry processing engine configured to generate a final geometry from the topology optimized geometry by:
conforming the topology optimized geometry to the original geometry at portions of the topology optimized geometry that correspond to fixed regions of the original geometry; and
smoothing the topology optimized geometry at portions that correspond to non-fixed regions of the original geometry.

13-15. (canceled)

16. The system of claim 12, wherein the geometry processing engine is configured to conform the topology optimized geometry to the original geometry by replacing the portions of the topology optimized geometry that correspond to fixed regions of the original geometry with the original geometry at the fixed regions.

17. The system of claim 16, wherein the geometry processing engine is configured to generate the final geometry as a convergent model,
wherein the fixed regions of the original geometry in the final geometry are represented as computer-aided design (CAD) geometry and the smoothed portions of the topology optimized geometry are represented as facets.

18. The system of claim 12, wherein the geometry processing engine is configured to smooth the topology optimized geometry by:
representing the topology optimized geometry at a finer granularity than a discretization granularity used for the topology optimization; and
smoothing the topology optimized geometry at the finer granularity.

19. The system of claim 12, wherein the original geometry comprises:
an overall geometry that sets boundary limits of the design space upon which the topology optimization process applies to; and
a fixed geometry that comprises a portion of the design space that is designated not to change; and
wherein the geometry processing engine is configured to conform the topology optimized geometry to the original geometry at portions of the topology optimized geometry that correspond to fixed regions of the original geometry by:
representing the overall geometry, the fixed geometry, and the topology optimized geometry at a finer granularity than a discretization granularity used for the topology optimization;
enriching, at the finer granularity, the topology optimized geometry to include portions of the fixed geometry that are missing in the topology optimized geometry due to removal by the topology optimization process; and
restricting, at the finer granularity, the topology optimized geometry to exclude portions of the topology optimized geometry that extend beyond the overall geometry.

20. A non-transitory machine-readable medium comprising instructions that, when executed by a processor, cause a computing system to:
access geometries associated with a topology optimization process, the geometries comprising:
an original geometry that represents a design space upon which the topology optimization process applies to; and
a topology optimized geometry that represents an output of the topology optimization process performed for the original geometry; and
generate a final geometry from the topology optimized geometry, including by:
conforming the topology optimized geometry to the original geometry at portions of the topology optimized geometry that correspond to fixed regions of the original geometry; and
smoothing the topology optimized geometry at portions that correspond to non-fixed regions of the original geometry.

21. The non-transitory machine-readable medium of claim 20, wherein the original geometry comprises:
an overall geometry that sets boundary limits of the design space upon which the topology optimization process applies to; and
a fixed geometry that comprises a portion of the design space that is designated not to change; and
wherein the instructions cause the computing system to conform the topology optimized geometry to the original geometry at portions of the topology optimized geometry that correspond to fixed regions of the original geometry by:
representing the overall geometry, the fixed geometry, and the topology optimized geometry at a finer granularity than a discretization granularity used for the topology optimization;
enriching, at the finer granularity, the topology optimized geometry to include portions of the fixed geometry that are missing in the topology optimized geometry due to removal by the topology optimization process; and
restricting, at the finer granularity, the topology optimized geometry to exclude portions of the topology optimized geometry that extend beyond the overall geometry.

22. The non-transitory machine-readable medium of claim 20, wherein the final geometry comprises a level-set geometry representation, and wherein the instructions further cause the computing system to:
extract a mesh representation of the final geometry from the level-set geometry representation; and
perform a Boolean operation between the mesh representation of the final geometry and the original geometry to remove a distortion to the final geometry that extends beyond the original geometry.

23. The non-transitory machine-readable medium of claim 22, wherein the instructions further cause the computing system to, in addition to smoothing the topology optimized geometry, smooth the mesh representation of the final geometry.
